(19) United States
(12) Patent Application Publication
(10) Pub. No.: US 2025/0324436 A1
(43) Pub. Date: Oct. 16, 2025

(54) METHOD AND USER EQUIPMENT FOR DETECTING MISSING DCI

(71) Applicant: MEDIATEK INC., Hsinchu City (TW)

(72) Inventors: Chung-Pi LEE, Hsinchu City (TW); Mingjun XU, Beijing (CN); Chunliu CAO, Beijing (CN); You-Ren ZHANG, Hsinchu City (TW); Tun-Ping HUANG, Hsinchu City (TW); Jianwei ZHANG, Beijing (CN); Wei-Jen CHEN, Hsinchu City (TW); Chung-Hsien HSIEH, Hsinchu City (TW)

(21) Appl. No.: 18/638,896

(22) Filed: Apr. 18, 2024

(30) Foreign Application Priority Data
Apr. 15, 2024 (CN) 202410451643.1

(51) Int. Cl. H04W 72/232

(52) U.S. Cl. CPC H04W 72/232

(57) ABSTRACT

A method for detecting missing downlink control information (DCI) is provided. The method is applied to a UE. It is determined that at least one of multiple scenarios is met based on modem layer information. A DCI-missing indicator with one of multiple criteria is generated according to the at least one scenario. Dynamic power mode control or throughput evaluation is performed according to the DCI-missing indicator.

### CROSS REFERENCE TO RELATED APPLICATIONS

This application claims priority of China Patent Application No. 202410451643.1, filed on Apr. 15, 2024, the entirety of which is incorporated by reference herein.

### BACKGROUND OF THE INVENTION

### Field of the Invention

The present invention relates to a method and user equipment (UE) for detecting missing downlink control information (DCI), and, in particular, to a method and UE for detecting missing DCI using a DCI-missing indicator.

### Description of the Related Art

User equipment (UE) may detect missed DCI events when the UE miss the DCI. However, accurately detecting the missed DCI events is highly challenging due to the absence of a reliable indicator for occurrence of the missed DCI events. How to generate the reliable indicator for detecting missing DCI becomes an important issue.

### BRIEF SUMMARY OF THE INVENTION

An embodiment of the present invention provides a method for detecting missing downlink control information (DCI). The method is applied to user equipment (UE). The method includes the following steps. It is determined that at least one of multiple scenarios is met based on modem layer information. The modem layer include physical layer and upper layer (for example, RLC layer, etc). The information include but not limited to new data indicator (NDI), redundancy version (RV), downlink assignment index (DAI), Modulation and Coding Scheme (MCS), HARQ information, packet serial number and other information which relate to block error rate (BLER), signal-to-noise ratio (SNR), package missing, traffic intensity and so on. A DCI-missing indicator with one of multiple criteria is generated according to said scenario. Dynamic power mode control or throughput evaluation is performed according to the DCI-missing indicator.

According to the method described above, the multiple criteria include a first criterion, a second criterion, and a third criterion. The probability of missing DCI for the DCI-missing indicator meeting the first criterion is higher than that for the DCI-missing indicator meeting the second criterion. The probability of missing DCI for the DCI-missing indicator meeting the second criterion is higher than that for the DCI-missing indicator meeting the third criterion.

According to the method described above, the step of determining that at least one of the scenarios is met based on the modem layer information includes the following steps. It is determined that a new data indicator (NDI) in the DCI is toggled, and it is determined that a redundancy version (RV) in the DCI is not equal to zero or a reserved MCS index for retransmission is used.

According to the method described above, the step of generating a DCI-missing indicator with one of multiple criteria according to said scenario includes the following step. The DCI-missing indicator with a first criterion is generated according to a scenario marked by the NDI in the DCI being toggled and the RV in the DCI not being equal to zero or the reserved MCS index for retransmission is used.

According to the method described above, the step of determining that at least one of the scenarios is met based on the modem layer information includes the following step. It is determined that the upper layer of the UE experiences a package missing.

According to the method described above, the step of determining that at least one of the scenarios is met based on the modem layer information further includes the following step. It is determined that a block error rate (BLER) of a physical downlink shared channel (PDSCH) at a physical layer of the UE is lower than a threshold after determining that upper layer of the UE experiences a package missing.

According to the method described above, the step of determining that at least one of the scenarios is met based on the modem layer information further includes the following step. It is determined that a count of a physical downlink shared channel (PDSCH) retransmission has not reached the upper limit after determining that the upper layer of the UE experiences a package missing.

According to the method described above, the step of generating a DCI-missing indicator with one of multiple criteria according to said scenario includes the following step. The DCI-missing indicator with a first criterion is generated according to a scenario marked by the upper layer of the UE experiencing a package missing.

According to the method described above, the step of determining that at least one of the scenarios is met based on the modem layer information includes the following step. It is determined that a downlink assignment index (DAI) in the DCI is not contiguous.

According to the method described above, the step of generating a DCI-missing indicator with one of multiple criteria according to said scenario includes the following step. The DCI-missing indicator with a first criterion is generated according to a scenario marked by the DAI in the DCI not being contiguous.

According to the method described above, the step of determining that at least one of the scenarios is met based on the modem layer information includes the following step. It is determined that the signal-to-noise ratio (SNR) measured at the physical downlink control channel (PDCCH) is lower than the threshold below which the PDCCH cannot be decoded successfully at the lowest aggregation level (AL).

According to the method described above, the step of generating a DCI-missing indicator with one of multiple criteria according to said scenario includes the following step. The DCI-missing indicator with a second criterion is generated according to a scenario marked by the SNR measured at the PDCCH being lower than the threshold.

According to the method described above, the step of determining that at least one of the scenarios is met based on the modem layer information includes the following steps. It is determined that the traffic intensity exceeds a first threshold during the previous time intervals. It is determined that the traffic intensity drops below a second threshold in the current time interval. And it is determined that hybrid automatic repeat request (HARQ) IDs are not contiguous during the current time interval.

According to the method described above, the step of generating a DCI-missing indicator with one of multiple criteria according to said scenario includes the following step. The DCI-missing indicator with a third criterion is generated according to a scenario marked by the traffic intensity exceeding the first threshold during the previous time intervals and the traffic intensity dropping below the second threshold in the current time interval and the HARQ IDs not being contiguous during the current time interval.

An embodiment of the present invention also provides user equipment (UE). The UE includes a processor. The processor determines that at least one of multiple scenarios is met based on modem layer information, generates a DCI-missing indicator with one of multiple criteria according to said scenario, and performs dynamic power mode control or throughput evaluation according to the DCI-missing indicator.

According to the UE described above, the multiple criteria include a first criterion, a second criterion, and a third criterion. A probability of missing DCI for the DCI-missing indicator meeting the first criterion is higher than that for the DCI-missing indicator meeting the second criterion. The probability of missing DCI for the DCI-missing indicator meeting the second criterion is higher than that for the DCI-missing indicator meeting the third criterion.

According to the UE described above, the scenarios include the processor determining that a new data indicator (NDI) in the DCI is toggled and a redundancy version (RV) in the DCI is not equal to zero or a reserved MCS index for retransmission is used.

According to the UE described above, the processor generates a DCI-missing indicator with a first criterion according to a scenario marked by the NDI in the DCI being toggled and the RV in the DCI not being equal to zero or the reserved MCS index for retransmission is used.

According to the UE described above, the scenarios include the processor determining that the upper layer of the UE experiences a package missing or a downlink assignment index (DAI) in the DCI is not contiguous.

According to the UE described above, the processor generates a DCI-missing indicator with a first criterion according to a scenario marked by the upper layer of the UE experiencing a package missing or the DAI in the DCI not being contiguous.

According to the UE described above, the scenarios include the processor determining that the signal-to-noise ratio (SNR) measured at the physical downlink control channel (PDCCH) is lower than the threshold below which the PDCCH cannot be decoded successfully at the lowest aggregation level (AL).

According to the UE described above, the processor generates a DCI-missing indicator with a second criterion according to a scenario marked by the SNR measured at the PDCCH being lower than the threshold.

According to the UE described above, the scenarios include the processor determining that the traffic intensity exceeds a first threshold during the previous time intervals and the traffic intensity drops below a second threshold in the current time interval and hybrid automatic repeat request (HARQ) IDs are not contiguous during the current time interval.

According to the UE described above, the processor generates a DCI-missing indicator with a third criterion according to a scenario marked by the traffic intensity exceeding the first threshold during the previous time intervals and the traffic intensity dropping below the second threshold in the current time interval and the HARQ IDs not being contiguous during the current time interval.

### BRIEF DESCRIPTION OF THE DRAWINGS

The present invention can be more fully understood by reading the subsequent detailed description and examples with references made to the accompanying drawings, wherein:

FIG. 1 is a flow chart of a method for detecting missing downlink control information (DCI) in accordance with some embodiments of the present invention.

FIG. 2 is a flow chart of a first scenario of the method for detecting missing DCI in FIG. 1 in accordance with some embodiments of the present invention.

FIG. 3 is a flow chart of a second scenario of the method for detecting missing DCI in FIG. 1 in accordance with some embodiments of the present invention.

FIG. 4 is a flow chart of a third scenario of the method for detecting missing DCI in FIG. 1 in accordance with some embodiments of the present invention.

FIG. 5 is a flow chart of a fourth scenario of the method for detecting missing DCI in FIG. 1 in accordance with some embodiments of the present invention.

FIG. 6 is a flow chart of a fifth scenario of the method for detecting missing DCI in FIG. 1 in accordance with some embodiments of the present invention.

FIG. 7 is a detail flow chart of step S102 of the method for detecting missing DCI in FIG. 1 in accordance with some embodiments of the present invention.

FIG. 8 is a schematic diagram of a communication system 800 in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” and/or “include” used in the present invention are used to indicate the existence of specific technical features, values, method steps, operations, units and/or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, and/or materials used in specific embodiments. However, the drawings should not be construed as defining or limiting the scope or properties encompassed by these embodiments. For example, for clarity, the relative size, thickness, and position of each layer, each area, and/or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, “third”, “fourth”, “fifth”, and “sixth” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

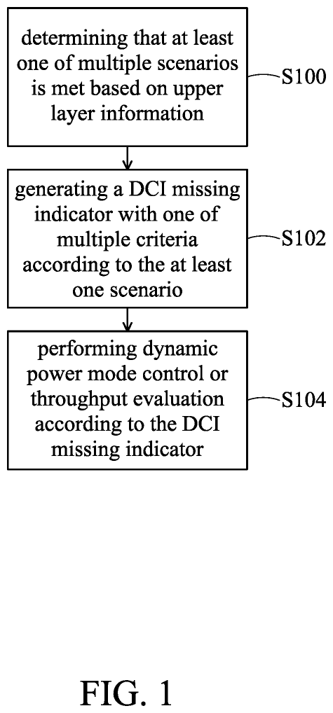

FIG. 1 is a flow chart of a method for detecting missing downlink control information (DCI) in accordance with some embodiments of the present invention. The method for detecting missing DCI of the present invention is applied to user equipment (UE). In some embodiments, the UE may be a laptop, a tablet, or a smart phone, but the present invention is not limited thereto. In some embodiments, the UE is included in a communication system, which further includes a base station. The UE is able to access a network through the base station. The UE is connected with the base station by Radio Resource Control (RRC) signaling, but the present invention is not limited thereto. In some embodiments, the base station may be a gNB, but the present invention is not limited thereto.

As shown in FIG. 1, the method for detecting missing DCI of the present invention includes the following steps. It is determined that at least one of multiple scenarios is met based on modem layer information (step S100). A DCI-missing indicator with one of multiple criteria is generated according to said scenario (step S102). Dynamic power mode control or throughput evaluation is performed according to the DCI-missing indicator (step S104). In some embodiments of step S100, the multiple scenarios are described as follows. For a first scenario, the UE determines that a new data indicator (NDI) in the DCI is toggled and determines that a redundancy version (RV) in the DCI is not equal to zero or a reserved modulation and coding scheme (MCS) index for retransmission is used. For a second scenario, the UE determines that the upper layer of the UE experiences a package missing. For a third scenario, the UE determines that a downlink assignment index (DAI) in the DCI is not contiguous.

Moreover, for a fourth scenario, the UE determines that the signal-to-noise ratio (SNR) measured at the physical downlink control channel (PDCCH) is lower than the threshold below which the PDCCH cannot be decoded successfully at the lowest aggregation level (AL). For a fifth scenario, the UE determines that the traffic intensity exceeds a first threshold during the previous time intervals and the traffic intensity drops below a second threshold in the current time interval and hybrid automatic repeat request (HARQ) IDs are not contiguous during the current time interval. In some embodiments, before step S100 is performed, the UE may receive information from its own radio link control (RLC) layer and/or physical layer, but the present invention is not limited thereto.

In some embodiments of step S102, the multiple criteria include a first criterion, a second criterion, and a third criterion. A probability of missing DCI for the DCI-missing indicator meeting the first criterion is higher than that for the DCI-missing indicator meeting the second criterion. The probability of missing DCI for the DCI-missing indicator meeting the second criterion is higher than that for the DCI-missing indicator meeting the third criterion. For example, when the first scenario, the second scenario, or the third scenario is met, the UE generates a DCI-missing indicator with a high criterion which has a high confidence level for missing DCI. When the fourth scenario is met, the UE generates a DCI-missing indicator with a middle criterion which has a middle confidence level for missing DCI. When the fifth scenario is met, the UE generates a DCI-missing indicator with a low criterion which has a low confidence level for missing DCI.

In step S104, the UE performs dynamic power mode control according to the DCI-missing indicator. The UE leverages the DCI-missing indicator with the high confidence level to switch between a high power mode and a low power mode. For example, when the DCI-missing indicator with the high confidence level is true, the UE uses the high power mode, otherwise uses the low power mode. That is, the UE utilizes the DCI-missing indicator to allocate power resources judiciously, enhancing power efficiency in modem operations. Moreover, in step S104, the UE also performs throughput evaluation according to the DCI-missing indicator. For example, the UE assesses the association between throughput performance and the absence of DCI, and utilizes the DCI-missing indicator as a diagnostic metric to investigate suboptimal throughput levels.

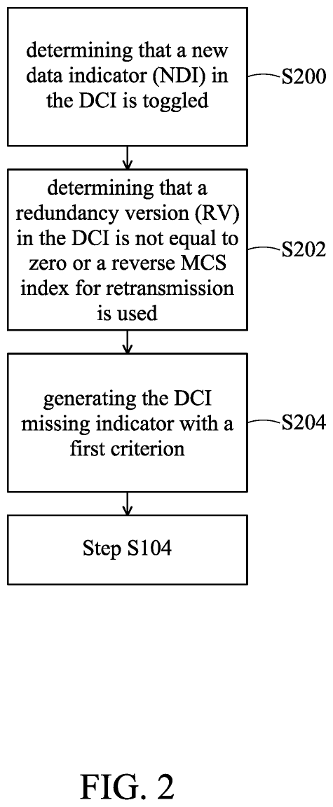

FIG. 2 is a flow chart of a first scenario of the method for detecting missing DCI in FIG. 1 in accordance with some embodiments of the present invention. As shown in FIG. 2, the method for detecting missing DCI of the present invention includes the following steps. It is determined that a new data indicator (NDI) in the DCI is toggled (step S200). It is determined that a redundancy version (RV) in the DCI is not equal to zero or the reserved MCS index for retransmission is used (step S202). The DCI-missing indicator with a first criterion is generated according to a scenario marked by the NDI in the DCI being toggled and the RV in the DCI not being equal to zero or the reserved MCS index for retransmission is used (step S204). After that, the UE performs the following step S104 in FIG. 1.

In step S200, the NDI is used to determine if a received transport block (TB) is a new transmission or a retransmission. When the NDI is toggled in DCI, it implies new data transmission. In step S202, when the RV in the DCI is not equal to zero or the reserved MCS index for retransmission is used, the data received from the network may not be contiguous. Therefore, high probability for missing DCI is indicated. For example, according to 3GPP specification, the RV in the DCI is not equal to zero, or one of the modulation and coding scheme (MCS) indexes 29-31 for MCS tables 1 and 3 and MCS indexes 28-31 for MCS table 2 is used. In step S204, the UE sets a DCI_missing_flag_high register to true to generate the DCI-missing indicator meeting the first criterion, but the present invention is not limited thereto.

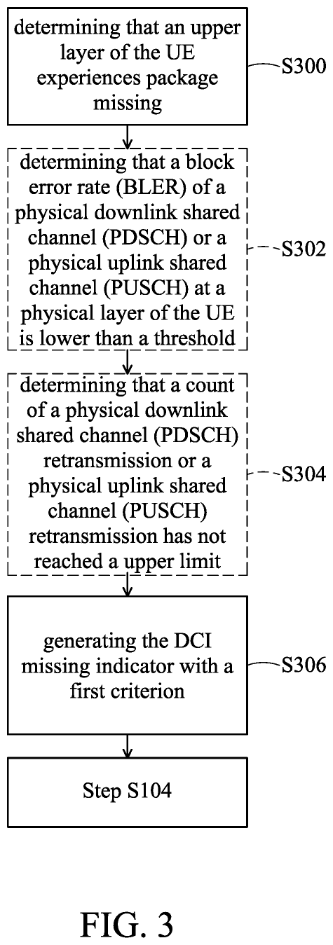

FIG. 3 is a flow chart of a second scenario of the method for detecting missing DCI in FIG. 1 in accordance with some embodiments of the present invention. As shown in FIG. 3, the method for detecting missing DCI of the present invention includes the following steps. It is determined that the upper layer of the UE experiences a package missing (step S300). It is determined that a block error rate (BLER) of a physical downlink shared channel (PDSCH) at a physical layer of the UE is lower than a threshold after determining that the upper layer of the UE experiences a package missing (step S302). It is determined that a count of a physical downlink shared channel (PDSCH) retransmission has not reached the upper limit after determining that the upper layer of the UE experiences a package missing (step S304). The DCI-missing indicator with a first criterion is generated according to a scenario marked by the upper layer of the UE experiencing a package missing (step S306). After that, the UE performs the following step S104 in FIG. 1.

In step S300, the upper layer of the UE may be an RLC layer of the UE. The missing package may be, for example, a sequence number (SN) count jump happening after a t-reassembly (t-reasm) counter or a t-reordering (t-ro) counter expiry. In step S302, the threshold may be 10%, but the present invention is not limited thereto. In step S304, the upper limit of the count is configured by the network. In some embodiments, step S302 and step S304 may be optional. For example, the UE may perform step S300, step S302, and step S306 to generate the DCI-missing indicator, but do not perform step S304. The UE may perform step S300, step S304, and step S306 to generate the DCI-missing indicator, but do not perform step S302. The UE may perform step S300 and S306 to generate the DCI-missing indicator, but do not perform step S302 and step S304. In step S306, the UE sets the DCI_missing_flag_high register to true to generate the DCI-missing indicator meeting the first criterion, but the present invention is not limited thereto.

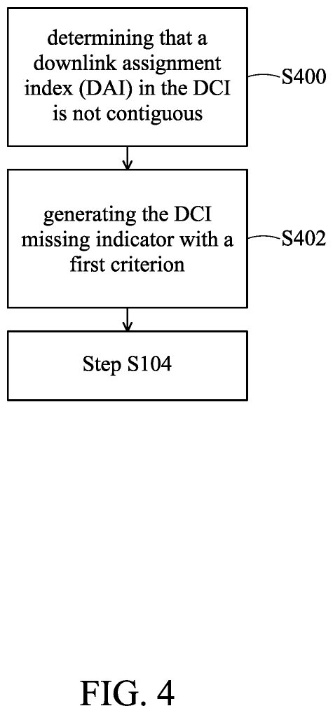

FIG. 4 is a flow chart of a third scenario of the method for detecting missing DCI in FIG. 1 in accordance with some embodiments of the present invention. As shown in FIG. 4, the method for detecting missing DCI of the present invention includes the following steps. It is determined that a downlink assignment index (DAI) in the DCI is not contiguous (step S400). The DCI-missing indicator with a first criterion is generated according to a scenario marked by the DAI in the DCI not being contiguous (step S402). After that, the UE performs the following step S104 in FIG. 1. In step S400, the DAI helps to avoid the issue created by missed transmission.

In some embodiments, the DAI may be a 2-bit field and it has a range of 1 to 4. It means that the DAI can detect maximum 3 missed transmissions. The gNB may provide DAI value along with PDSCH and if UE detects any missed value of the DAI, then UE may assume missed transmission and map negative acknowledgement in codebook. In step S402, the UE sets the DCI_missing_flag_high register to true to generate the DCI-missing indicator meeting the first criterion, but the present invention is not limited thereto.

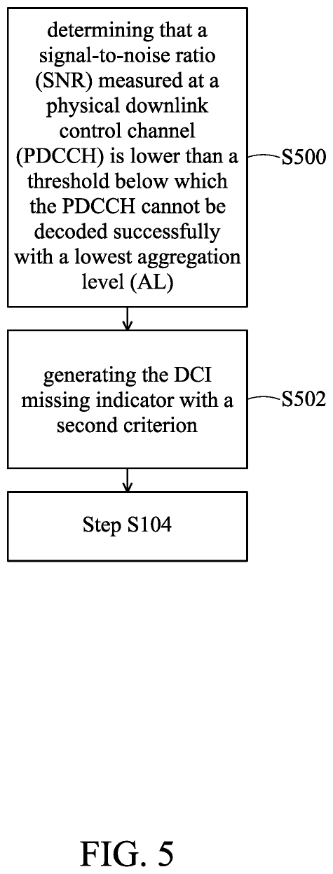

FIG. 5 is a flow chart of a fourth scenario of the method for detecting missing DCI in FIG. 1 in accordance with some embodiments of the present invention. As shown in FIG. 5, the method for detecting missing DCI of the present invention includes the following steps. It is determined that the signal-to-noise ratio (SNR) measured at the physical downlink control channel (PDCCH) is lower than the threshold below which the PDCCH cannot be decoded successfully at the lowest aggregation level (AL) (step S500). The DCI-missing indicator with a second criterion is generated according to a scenario marked by the SNR measured at the PDCCH being lower than the threshold (step S502). After that, the UE performs the following step S104 in FIG. 1. In step S500, the threshold can be adaptive to different realizations. The threshold may be, for example, 0.5 dB, but the present invention is not limited thereto. In step S502, the UE sets the DCI_missing_flag_medium register to true to generate the DCI-missing indicator meeting the second criterion, but the present invention is not limited thereto.

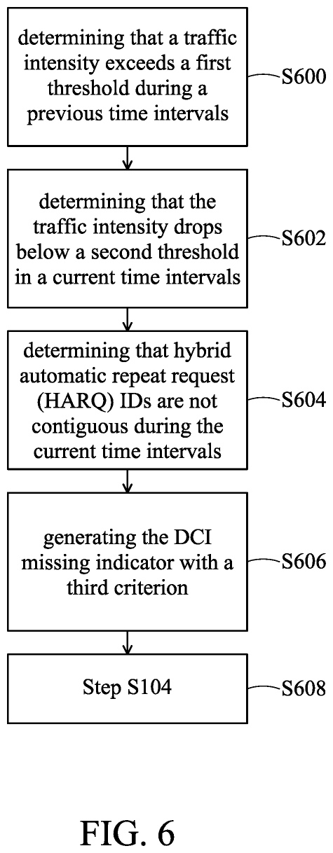

FIG. 6 is a flow chart of a fifth scenario of the method for detecting missing DCI in FIG. 1 in accordance with some embodiments of the present invention. As shown in FIG. 6, the method for detecting missing DCI of the present invention includes the following steps. It is determined that the traffic intensity exceeds a first threshold during the previous time intervals (step S600). It is determined that the traffic intensity drops below a second threshold in the current time interval (step S602). It is determined that hybrid automatic repeat request (HARQ) IDs are not contiguous during the current time interval (step S604). The DCI-missing indicator with a third criterion is generated according to a scenario marked by the traffic intensity exceeding the first threshold during the previous time intervals and the traffic intensity dropping below the second threshold in the current time interval and the HARQ IDs not being contiguous during the current time interval (step S606). After that, the UE performs the following step S104 in FIG. 1.

In step S600, the previous time intervals may be the last 50 subframes. In some embodiments, the traffic intensity may be, for example, number of PDSCH slots divided by number of downlink slots, but the present invention is not limited thereto. In some embodiments, the first threshold may be 50%, but the present invention is not limited thereto. In step S602, the current time interval may be 10 subframes. The second threshold may be equal to the first threshold multiplied by 0.6, for example, 30%, but the present invention is not limited thereto. In step S604, the current time interval may be 10 subframes. In step S606, the UE sets the DCI_missing_flag_low register to true to generate the DCI-missing indicator meeting the third criterion, but the present invention is not limited thereto.

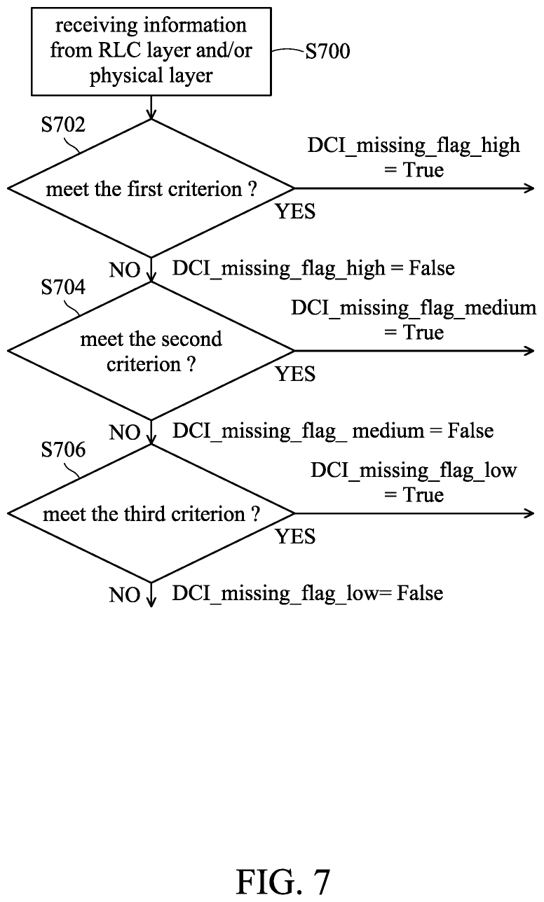

FIG. 7 is a detail flow chart of step S102 of the method for detecting missing DCI in FIG. 1 in accordance with some embodiments of the present invention. As shown in FIG. 7, the method for detecting missing DCI of the present invention includes the following steps. Information is received from RLC layer and/or physical layer of the UE (step S700). It is determined whether the first criterion is met (step S702). It is determined whether the second criterion is met (set S704). It is determined whether the third criterion is met (step S706). In step S702, when the first scenario in FIG. 2, the second scenario in FIG. 3, and the third scenario in FIG. 4 are met, the first criterion is met. If the first criterion is met, the UE sets the DCI_missing_flag_high register to true to generate the DCI-missing indicator meeting the first criterion, and step S102 in FIG. 1 is finished. If the first criterion is not met, the UE sets the DCI_missing_flag_high register to false and forwards to step S704.

In step S704, when the fourth scenario in FIG. 5 is met, the second criterion is met. If the second criterion is met, the UE sets the DCI_missing_flag_middle register to true to generate the DCI-missing indicator meeting the second criterion, and step S102 in FIG. 1 is finished. If the second criterion is not met, the UE sets DCI_missing_flag_middle register to false and forwards to step S706. In step S706, when the fifth scenario in FIG. 6 is met, the third criterion is met. If the third criterion is met, the UE sets the DCI_missing_flag_low register to true to generate the DCI-missing indicator meeting the third criterion, and step S102 in FIG. 1 is finished. If the third criterion is not met, the UE sets DCI_missing_flag_low register to false, so that the DCI-missing indicator is not generated.

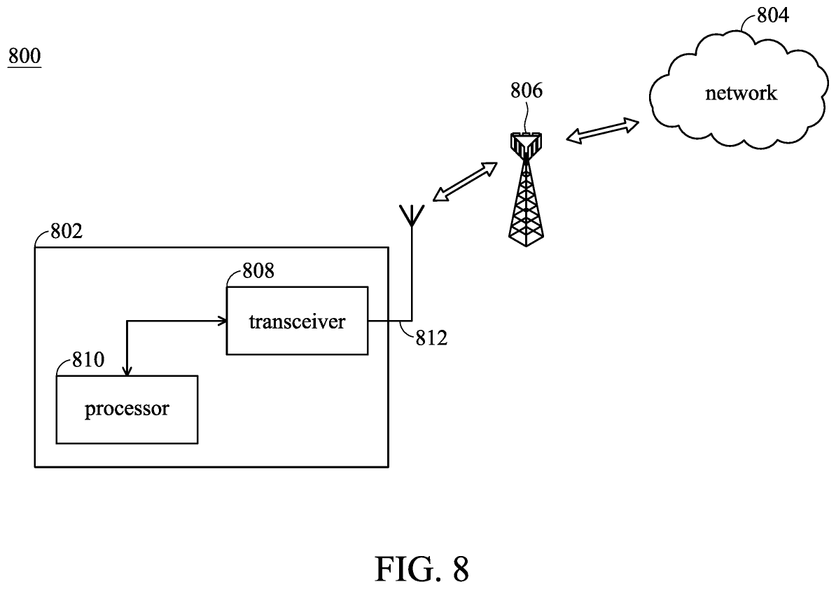

FIG. 8 is a schematic diagram of a communication system 800 in accordance with some embodiments of the present invention. As shown in FIG. 8, the communication system 800 includes a UE 802, a network 804, and a base station 806. In some embodiments, the UE 802 may be a laptop, a tablet, or a smart phone, but the present invention is not limited thereto. In some embodiments, the UE 802 is able to access the network 804 through the base station 806. The UE 802 is connected with the base station 806 by Radio Resource Control (RRC) signaling, but the present invention is not limited thereto. In some embodiments, the base station 806 may be a gNB, but the present invention is not limited thereto.

In some embodiments, the UE 802 includes an antenna 812, a transceiver 808, and a processor 810. The transceiver 808 is electrically connected between the antenna 812 and the processor 810. The processor 810 may be a modem, but the present invention is not limited thereto. In some embodiments, the UE 802 further includes a memory (not shown) storing a plurality of codes. The processor 810 reads the codes stored in the memory to execute the steps as follows. The processor 810 determines that at least one of multiple scenarios is met based on modem layer information, generates a DCI-missing indicator with one of multiple criteria according to said scenario, and performs dynamic power mode control or throughput evaluation according to the DCI-missing indicator.

In some scenarios, the processor 810 determines that a new data indicator (NDI) in the DCI is toggled and a redundancy version (RV) in the DCI is not equal to zero or a reserved MCS index for retransmission is used. After that, the processor 810 generates a DCI-missing indicator with a first criterion according to a scenario marked by the NDI in the DCI being toggled and the RV in the DCI not being equal to zero.

In some scenarios, the processor 810 determines that the upper layer of the UE 802 experiences a package missing. Optionally, the processor 810 determines that a block error rate (BLER) of a physical downlink shared channel (PDSCH) at a physical layer of the UE 802 is lower than a threshold after determining that the upper layer of the UE 802 experiences a package missing. Optionally, the processor 810 determines that a count of a PDSCH retransmission has not reached the upper limit after determining that the upper layer of the UE 802 experiences a package missing. After that, the processor 810 generates a DCI-missing indicator with a first criterion according to a scenario marked by the upper layer of the UE 802 experiencing a package missing.

In some scenarios, the processor 810 determines that a downlink assignment index (DAI) in the DCI is not contiguous. The processor 810 generates a DCI-missing indicator with a first criterion according to a scenario marked by the DAI in the DCI not being contiguous.

In some scenarios, the processor 810 determines that the signal-to-noise ratio (SNR) measured at the physical downlink control channel (PDCCH) is lower than the threshold below which the PDCCH cannot be decoded successfully at the lowest aggregation level (AL). The processor 810 generates a DCI-missing indicator with a second criterion according to a scenario marked by the SNR measured at the PDCCH being lower than the threshold.

In some scenarios, the processor 810 determines that the traffic intensity exceeds a first threshold during the previous time intervals and the traffic intensity drops below a second threshold in the current time interval and hybrid automatic repeat request (HARQ) IDs are not contiguous during the current time interval. The processor 810 generates a DCI-missing indicator with a third criterion according to a scenario marked by the traffic intensity exceeding the first threshold during the previous time intervals and the traffic intensity dropping below the second threshold in the current time interval and the HARQ IDs not being contiguous during the current time interval.

In some embodiments, the probability of missing DCI for the DCI-missing indicator meeting the first criterion is higher than that for the DCI-missing indicator meeting the second criterion. The probability of missing DCI for the DCI-missing indicator meeting the second criterion is higher than that for the DCI-missing indicator meeting the third criterion.

The detection mechanism of the method for detecting missing DCI of the present invention offers varying levels of reliability in providing indicators for missing DCI, ranging from high to low. The method for detecting missing DCI of the present invention provides robust indication with granular confidence levels. The method for detecting missing DCI of the present invention provides more granular levels of confidence and enhances the overall reliability if the detection mechanism.

The detection mechanism of the method for detecting missing DCI of the present invention provides holistic information integration for accurate detection. The method for detecting missing DCI of the present invention incorporates indicators from diverse layers (e.g., RLC layer and physical layer) to provide a more accurate DCI-missing indicator.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for detecting missing downlink control information (DCI), applied to user equipment (UE), comprising:
determining that at least one of multiple scenarios is met based on modem layer information;
generating a DCI-missing indicator with one of multiple criteria according to the at least one scenario; and
performing dynamic power mode control or throughput evaluation according to the DCI-missing indicator.

2. The method as claimed in claim 1, wherein the multiple criteria comprise a first criterion, a second criterion, and a third criterion;
wherein a probability of missing DCI using the DCI-missing indicator meeting the first criterion is higher than that that using the DCI-missing indicator meeting the second criterion; and
wherein the probability of missing DCI using the DCI-missing indicator meeting the second criterion is higher than that using the DCI-missing indicator meeting the third criterion.

3. The method as claimed in claim 1, wherein the step of determining that at least one of the scenarios is met based on the modem layer information in the DCI comprises:
determining that a new data indicator (NDI) in the DCI is toggled; and
determining that a redundancy version (RV) in the DCI is not equal to zero or a reserved modulation and coding scheme (MCS) index for retransmission is used.

4. The method as claimed in claim 3, wherein the step of generating the DCI-missing indicator with one of multiple criteria according to the at least one scenario comprises:
generating the DCI-missing indicator with a first criterion according to a scenario marked by the NDI in the DCI being toggled and the RV in the DCI not being equal to zero or the reserved MCS index for retransmission is used.

5. The method as claimed in claim 1, wherein the step of determining that at least one of the scenarios is met based on the modem layer information comprises:
determining that an upper layer of the UE experiences a package missing.

6. The method as claimed in claim 5, wherein the step of determining that at least one of the scenarios is met based on the modem layer information further comprises:
determining that a block error rate (BLER) of a physical downlink shared channel (PDSCH) at a physical layer of the UE is lower than a threshold after determining that the upper layer of the UE experiences a package missing.

7. The method as claimed in claim 5, wherein the step of determining that at least one of the scenarios is met based on the modem layer information further comprises:
determining that a count of a physical downlink shared channel (PDSCH) retransmission has not reached an upper limit after determining that the upper layer of the UE experiences a package missing.

8. The method as claimed in claim 5, wherein the step of generating the DCI-missing indicator with one of multiple criteria according to the at least one scenario comprises:
generating the DCI-missing indicator with a first criterion according to a scenario marked by the upper layer of the UE experiencing a package missing.

9. The method as claimed in claim 1, wherein the step of determining that at least one of the scenarios is met based on the modem layer information comprises:
determining that a downlink assignment index (DAI) in the DCI is not contiguous.

10. The method as claimed in claim 9, wherein the step of generating the DCI-missing indicator with one of multiple criteria according to the at least one scenario comprises:
generating the DCI-missing indicator with a first criterion according to a scenario marked by the DAI in the DCI not being contiguous.

11. The method as claimed in claim 1, wherein the step of determining that at least one of the scenarios is met based on the modem layer information comprises:
determining that a signal-to-noise ratio (SNR) measured at a physical downlink control channel (PDCCH) is lower than a threshold below which the PDCCH cannot be decoded successfully at a lowest aggregation level (AL).

12. The method as claimed in claim 11, wherein the step of generating the DCI-missing indicator with one of multiple criteria according to the at least one scenario comprises:
generating the DCI-missing indicator with a second criterion according to a scenario marked by the SNR measured at the PDCCH being lower than the threshold.

13. The method as claimed in claim 1, wherein the step of determining that at least one of the scenarios is met based on the modem layer information comprises:
determining that traffic intensity exceeds a first threshold during previous time intervals;
determining that the traffic intensity drops below a second threshold in current time intervals; and
determining that hybrid automatic repeat request (HARQ) IDs are not contiguous during the current time interval.

14. The method as claimed in claim 13, wherein the step of generating the DCI-missing indicator with one of multiple criteria according to the at least one scenario comprises:
generating the DCI-missing indicator with a third criterion according to a scenario marked by the traffic intensity exceeding the first threshold during the previous time intervals and the traffic intensity dropping below the second threshold in the current time interval and the HARQ IDs not being contiguous during the current time interval.

15. User equipment (UE), comprising:
a processor, configured to determine that at least one of multiple scenarios is met based on modem layer information, generate a DCI-missing indicator with one of multiple criteria according to the at least one scenario, and perform dynamic power mode control or throughput evaluation according to the DCI-missing indicator.

16. The UE as claimed in claim 15, wherein the multiple criteria comprise a first criterion, a second criterion, and a third criterion; the probability of missing DCI for the DCI-missing indicator meeting the first criterion is higher than that for the DCI-missing indicator meeting the second criterion; and the probability of missing DCI for the DCI-missing indicator meeting the second criterion is higher than that for the DCI-missing indicator meeting the third criterion.

17. The UE as claimed in claim 15, wherein the scenarios comprise the processor determining that a new data indicator (NDI) in the DCI is toggled and a redundancy version (RV) in the DCI is not equal to zero or a reserved modulation and coding scheme (MCS) index for retransmission is used.

18. The UE as claimed in claim 15, wherein the scenarios comprise the processor determining that the upper layer of the UE experiences a package missing or a downlink assignment index (DAI) in the DCI is not contiguous.

19. The UE as claimed in claim 15, wherein the scenarios comprise the processor determining that a signal-to-noise ratio (SNR) measured at a physical downlink control channel (PDCCH) is lower than a threshold below which the PDCCH cannot be decoded successfully with the lowest aggregation level (AL).

20. The UE as claimed in claim 15, wherein the scenarios comprise the processor determining that the traffic intensity exceeds a first threshold during the previous time intervals and the traffic intensity drops below a second threshold in the current time interval and hybrid automatic repeat request (HARQ) IDs are not contiguous during the current time interval.
